(19) United States
(12) Patent Application Publication
(10) Pub. No.: US 2018/0191931 A1
(43) Pub. Date: Jul. 5, 2018

(54) SECURITY VIDEO CAMERA INSERTABLE INTO AN EXTERIOR LIGHT SOCKET FOR ELECTRICAL POWER AND ASSOCIATED SYSTEMS, DEVICES, AND METHODS

(71) Applicant: ECHOSTAR TECHNOLOGIES L.L.C., Englewood, CO (US)

(72) Inventors: Richard Bly, Atlanta, GA (US); Hank Caughman, Atlanta, GA (US); Mitch Kapa, Atlanta, GA (US); David Lett, Atlanta, GA (US); Tony McCarthy, Atlanta, GA (US)

(21) Appl. No.: 15/859,651

(22) Filed: Dec. 31, 2017

Related U.S. Application Data
(60) Provisional application No. 62/441,303, filed on Dec. 31, 2016.

(51) Int. Cl. H04N 5/225; H01R 33/22

(52) U.S. Cl. CPC H04N 5/2257; H04W 84/12; H01R 33/22; H04N 5/2253

(57) ABSTRACT

A camera system includes: an IP camera that comprises a threadable power connection; a mounting/positioning apparatus connected to the IP camera that physically connects the IP camera to a building structure at an exterior portion of the building structure, wherein the mounting/positioning includes a light socket for supplying power to the IP camera; optionally a WiFi bridge that is electrically connected to an interior power outlet of a building structure; and a wireless router that wirelessly connects with the WiFi bridge or camera for the transmission of data between the wireless router and the WiFi bridge.

### CROSS-REFERENCE TO RELATED APPLICATIONS

This Application claims priority to U.S. Provisional Patent Application No. 62/441,303, filed on Dec. 31, 2016, the contents of which are incorporated by reference herein in their entirety.

### TECHNICAL FIELD

The present disclosure relates generally to video camera-enabled systems, devices, and methods. More particularly, the present disclosure relates to electronic cameras that have threaded electrical receivers for insertion into an exterior light socket, and associated systems, devices, and methods, particularly as applied to home security system implementations.

### BACKGROUND

Communications networks are commonly used to enable end devices such as computers, servers, cameras, memory devices and the like to communicate with each other and/or to communicate with remote devices via one or more external telecommunications links. These networks include, among other things, communications and connectors (also referred to herein as “connector ports”) that are used to interconnect the end devices, as well as network switches and routers that are used to route communications between the end devices. The network switch routes data signals that are transmitted from the end device toward their intended destinations (e.g., to other end devices, an external network, etc.), and likewise routes incoming data signals to the end device, as appropriate.

Security systems employing cameras have long been used by businesses and other organizations as a way to provide security and privacy. In many cases, security systems are not an easy add-on to a home. As a result, most security systems that use cameras are too complex and expensive for a user to implement in a home setting. Additionally, many after-market security systems are not easily integrated into a home without appearing out-of-place or creating a poor aesthetic. Home security is particularly important when the user needs to answer the doorbell, has small children, or is away from the home temporarily or for extended periods of time. Existing security systems are not easily integrated and do not allow efficient access to security content in or away from the home. For example, using conventional Ethernet cables that have a generally circular cross-section for purposes of providing data and electrical connectivity to a home security camera, it is typically necessary to drill a hole in the home's wall at the camera installation location for feeding the Ethernet cable through. Thus, wireless systems may be preferable in many instances. However, the manner in which such wireless systems obtain their electrical power, in the prior art, has heretofore proven less-than-desirable.

As such, there is a continuing need in the art for systems and methods that allow for improved installation of wireless-enabled home security cameras. Moreover, other desirable features and characteristics of the present disclosure will become apparent from the subsequent detailed description the appended claims, taken in conjunction with the accompanying drawings and background.

### BRIEF SUMMARY

The various embodiments disclosed herein relate to security cameras that include a threadable power member that is configured to be insertable and receive power from a standard light socket (depending on size) and associated systems, devices, and methods, particularly as applied to home security system implementations. In one exemplary embodiment, disclosed herein is a security camera system includes: an IP camera that comprises a threadable power connection; a mounting/positioning apparatus connected to the IP camera that physically connects the IP camera to a building structure at an exterior portion of the building structure, wherein the mounting/positioning includes a light socket for supplying power to the IP camera; optionally a WiFi bridge that is electrically connected to an interior power outlet of a building structure; and a wireless router that wirelessly connects with the WiFi bridge for the transmission of data between the wireless router and the WiFi bridge, or the IP camera. The IP camera receives power from the light socket, but transmits its video signal via WiFi to the bridge or the wireless router, for example. Thus, no wired connection is needed from the exterior of the house or building into the interior thereof.

In another exemplary embodiment, a method for implementing a camera system includes providing a wireless camera that comprises a threadable power connection and connecting the wireless camera to a mounting/positioning apparatus so as to physically connect the wireless camera to a building structure at an exterior portion of the building structure. The mounting/positioning apparatus comprises a light socket for supplying electrical power to the wireless camera. The method further includes positioning a wireless router to be located within the building structure and activating the wireless router to wirelessly connect with the wireless camera for the transmission of data between the wireless router and the wireless camera.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE FIGURES

The disclosed embodiments will hereinafter be described in conjunction with the following drawing figures, wherein like numerals denote like elements, and wherein:

FIG. 1 shows an exemplary implementation of a home security camera system using a light socket for electrical power;

FIG. 2 shows an exemplar threaded light socket connection as may be used in accordance with embodiments, herein; and

FIG. 3 shows an exemplary security camera, which may use a threaded power receiver, in accordance with some embodiments herein.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Embodiments of the present disclosure are generally directed to cameras receiving their power from a light socket and associated systems, devices, and methods, particularly as applied to home security system implementations. While a “home” security implantation is described herein, the disclosure is readily extendable to other security camera implementations, such as business, commercial, or other implementations on buildings. In an embodiment, a home security camera is installed on an exterior portion of a user's house or business. A first security camera is provided and configured to provide a wireless data signal, using an electrical connection from a light socket, which may be an exterior light socket. The home security camera may be mounted and installed along the exterior of the house/business.

The security camera may optionally connect to a WiFi bridge that is plugged into a power outlet of the house for purposes of enhanced connectivity, and connects wirelessly to an internet/WiFi router in the house for purposes of data connectivity. In some implementations, the security camera connects wirelessly to the WiFi router without the need for a bridge, in instances where the router is in close enough physical proximity to the exterior-mounted security camera for purposes of achieving a sufficient WiFi signal. Communication may, in some embodiments, be secure on the outside of the house to block any intruders from accessing the home network by disconnecting the outdoor light socket from the camera and connecting to their PC. This is accomplished by secure hardware cryptography locking the bridge/router to the camera. The outdoor portion is powered by the light socket connection and sends data via wireless connection, for example the bridge or router, as the case may be.

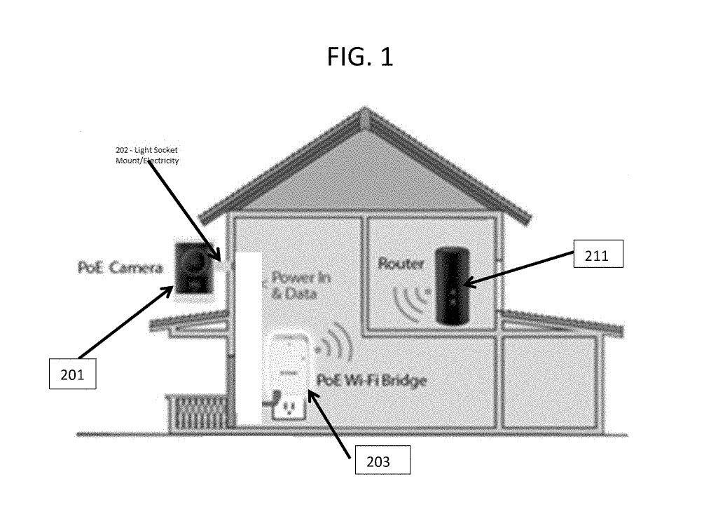

Referring now to FIG. 1, the home security camera system is illustrated. The system includes camera 201, which may be mounted to the home by means of a light socket 202 on the exterior of the home. In some embodiments, camera 201 may be an IP camera. An Internet protocol (IP) camera may include a digital camera for capturing photos and/or video. IP cameras may send and receive data via a computer network or the Internet. IP cameras may be employed for any of a number of applications, such as surveillance, telecommunication, and social networking, just to name a few examples. Many such cameras for home security are known in the art, and thus the exact implementation of camera 201 is not intended to be limiting, and neither is its mounting and positioning apparatus, again, many configurations of which are known in the art.

Many houses, or buildings in general, include exterior lighting, such as light socket 202. Exterior lighting is generally facilitated by the insertion of light bulbs into light sockets, which supply the power to light bulbs. In some embodiments of the present disclosure, the camera 201 is designed so as to receive power from a light socket as may be found at the exterior of a house or building. As is known in the art, a light socket generally includes a threaded receptacle with an electrical connection at the base thereof. Thus, in some embodiments, a security camera such as camera 201 may include a threaded member, in the manner of the base portion (the electrical power receiving portion) of a conventional light bulb, or a CFL bulb, or an LED bulb, or the like. The base portion is threaded to be receivable into the aforementioned threaded receptacle. Thus, in this manner, where a building includes an exterior light socket 202, the camera 201 of the present disclosure may receive power (for example, in place of a conventional light bulb).

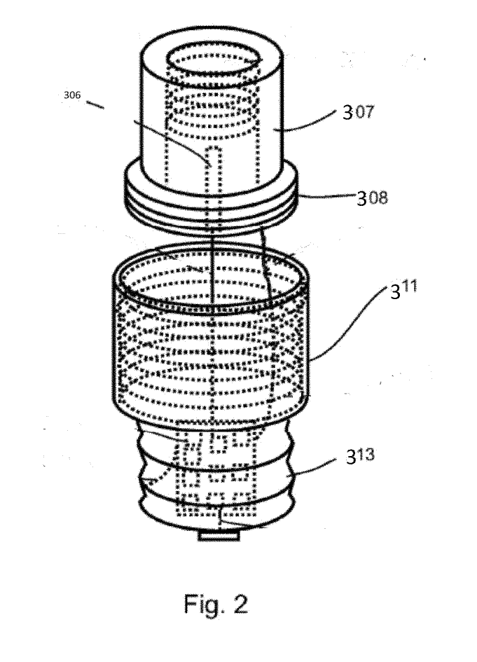

For example, FIG. 2 illustrates the threaded connection between an exterior lighting socket 202 and a device that is receivable into the exterior lighting socket for receiving power, such as camera 201. In the illustration of FIG. 2, portions 306, 307, and 308 form parts of camera 201, whereas parts 311 and 313 form parts of the lighting socket 202. As illustrated, the camera 201 power connection includes a base portion 307 and a threaded portion 308 connected to the base portion (the rest of the camera, not illustrated in FIG. 2, is connected to the base portion 307). An electrical receiver 306 is disposed within the base portion 307 to supply power to camera 201. The socket 202 includes threaded receiving member 311 and base portion 313. The threaded receiving member receives the threaded portion 308. The base portion includes a power supply source for connecting with the electrical receiver 306. Referring back to FIG. 1, once power is received at camera 201 using this lighting socket connection 202, a WiFi connection may be enabled from the camera (device) 201 to an interior bridge 203 or router 211, which as illustrated may be located at various locations within the home, whereas the camera 201 is outside of the home.

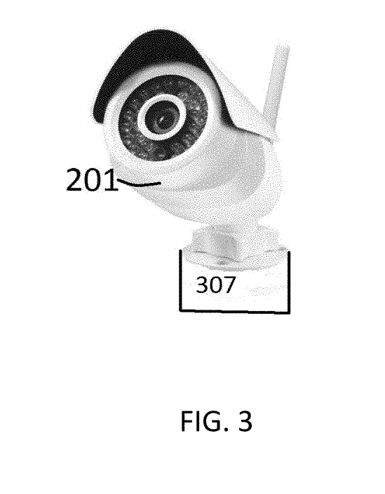

FIG. 3 illustrates an exemplary home security camera 201, which may be configured to receive its power from a light socket-type extension, base portion 307 of which is illustrated. That is, the security camera of FIG. 3 may, though not illustrated, include a threaded member 308 for receiving power from a light socket 202 (i.e., being rotatably insertable into a light socket member 311), for example as shown in FIG. 2. Via a wireless connection, the camera 201 may connect with WiFi bridge 203 or router 211, as the case may be. Network bridging is the action taken by network equipment to create an aggregate network from either two or more communication networks, or two or more network segments. Bridging is distinct from routing which allows the networks to communicate independently as separate networks. Also, if one or more segments of the network are wireless, it is known as wireless bridging. A network bridge is a network device that connects multiple network segments. When present, therefore, WiFi bridge 203 plugs into an electrical outlet within the home or building, and wirelessly communicates with the home's network via wireless router 211.

The foregoing-described system may be part of a broader wireless home security and/or home automation system. As is generally known in the art, wireless networks are typically advantageous over their wired counterparts, because they eliminate the need for stringing lengths of wire around a network site. This is especially useful in a home or enterprise security system in which multiple surveillance cameras and various sensors may be strategically placed around, both inside and outside, the home or office. Wireless networks further have the advantage that they cannot be easily circumvented by merely cutting the wired connections to network devices. One conventional technique for adding a new device to a home network requires user input to provide configuration information. For example, a user can purchase a wireless device that is, typically, initially configured as an access point (AP) device. The user can use their mobile device to identify this AP device on their WiFi network and enter a password. The wireless device/AP device requests configuration information from the user of the mobile device, for example, a home router network service set identifier “SSID” and password. The user provides the requested information through the mobile device using an appropriate application. The wireless device/AP device is rebooted as a client device. An association is then made and the IP device is coupled to the home network.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiments in any way. Rather, the foregoing detailed description will provide those skilled in the art with a convenient road map for implementing an exemplary embodiment, it being understood that various changes may be made in the function and arrangement of elements described and methods of preparation in an exemplary embodiment without departing from the scope of the invention, which is set forth in the appended claims and their legal equivalents.

What is claimed is:

1. A camera system comprising:
a wireless camera that comprises a threadable power connection;
a mounting/positioning apparatus connected to the wireless camera that physically connects the wireless camera to a building structure at an exterior portion of the building structure, wherein the mounting/positioning apparatus comprises a light socket for supplying electrical power to the wireless camera; and
a wireless router located within the building structure that wirelessly connects with the wireless camera for the transmission of data between the wireless router and the wireless camera.

2. The camera system of claim 1, wherein the wireless camera is an IP camera.

3. The camera system of claim 1, wherein the transmission of data comprises the transmission of image data.

4. The camera system of claim 1, further comprising a WiFi bridge that is electrically connected to an interior power outlet of the building structure, and which relays the transmission of data from the wireless camera to the wireless router.

5. The camera system of claim 1, wherein the threadable power connection comprises a base portion and a threaded portion, wherein the base portion connects the threaded portion to an image receiving lens apparatus of the wireless camera.

6. The camera system of claim 1, wherein the light socket is configured in a manner such that a light bulb is able to be threadably inserted therein and receive electrical power therefrom for operation of the light bulb.

7. The camera system of claim 6, wherein the threadable power connection is configured in the manner of a threaded connection portion of a light bulb.

8. The camera system of claim 1, wherein the building structure comprises a residential structure or a commercial business structure.

9. The camera system of claim 1, wherein the light socket is connected to a power supply of the building structure and is configured to supply electrical power from the power supply of the building structure to the wireless camera.

10. The camera system of claim 1, wherein the camera system comprises a portion of a security system for the building structure.

11. A method for implementing a camera system comprising:
providing a wireless camera that comprises a threadable power connection;
connecting the wireless camera to a mounting/positioning apparatus so as to physically connect the wireless camera to a building structure at an exterior portion of the building structure, wherein the mounting/positioning apparatus comprises a light socket for supplying electrical power to the wireless camera; and
positioning a wireless router to be located within the building structure and activating the wireless router to wirelessly connect with the wireless camera for the transmission of data between the wireless router and the wireless camera.

12. The method of claim 11, wherein the wireless camera is an IP camera.

13. The method of claim 11, wherein the transmission of data comprises the transmission of image data.

14. The method of claim 11, further comprising installing a WiFi bridge in electrical connection to an interior power outlet of the building structure, and configuring the WiFi bridge so as to relay the transmission of data from the wireless camera to the wireless router.

15. The method of claim 11, wherein the threadable power connection comprises a base portion and a threaded portion, wherein the base portion connects the threaded portion to an image receiving lens apparatus of the wireless camera.

16. The method of claim 11, wherein the light socket is configured in a manner such that a light bulb is able to be threadably inserted therein and receive electrical power therefrom for operation of the light bulb.

17. The method of claim 16, wherein the threadable power connection is configured in the manner of a threaded connection portion of a light bulb.

18. The method of claim 11, wherein the building structure comprises a residential structure or a commercial business structure.

19. The method of claim 11, wherein the light socket is connected to a power supply of the building structure and is configured to supply electrical power from the power supply of the building structure to the wireless camera.

20. The method of claim 11, wherein the camera system is implemented as a portion of a security system for the building structure.
